(19) United States
(12) Patent Application Publication
(10) Pub. No.: US 2025/0184042 A1
(43) Pub. Date: Jun. 5, 2025

(54) METHOD FOR MANAGING A RETRANSMISSION OF DATA EXCHANGED ON A PATH ESTABLISHED BETWEEN A FIRST COMMUNICATION EQUIPMENT AND A SECOND COMMUNICATION EQUIPMENT BY WAY OF A VALUE OF AN INTERMEDIATE PERFORMANCE PARAMETER DETERMINED BY AN INTERMEDIATE NODE BELONGING TO SAID PATH

(71) Applicant: ORANGE, Issy-les-Moulineaux (FR)

(72) Inventor: Emile STEPHAN, Châtillon (FR)

(21) Appl. No.: 18/846,101

(22) PCT Filed: Mar. 3, 2023
(86) PCT No.: PCT/EP2023/055394

§ 371 Date: Sep. 11, 2024

(30) Foreign Application Priority Data
Mar. 11, 2022 (FR) FR2202179

(51) Int. Cl. H04L 1/18; H04L 43/0829; H04L 43/0864; H04L 43/16

(52) U.S. Cl. CPC H04L 1/18; H04L 43/0829; H04L 43/0864; H04L 43/16

(57) ABSTRACT

A method for improving the cooperation between two communication equipments constituting the ends of a path having at least one intermediate equipment. End-to-end encryption systems are designed to be resistant to any attempts of surveillance or tampering, as no third party can decrypt or alter the data being communicated. This reduction in cooperation between the communication equipments located at the ends of the connection and the intermediate equipments negatively impacts the performance of a connection established on the communication path comprising intermediate equipments. The method for improving cooperation makes it possible to re-establish cooperation between communication equipments that constitute the ends of a connection with intermediate nodes by calculating an intermediate performance parameter.

### FIELD OF THE INVENTION

The field of the invention is that of data transmission. More specifically, the invention relates to improving the cooperation between two pieces of communication equipment constituting the ends of a path comprising at least one intermediate equipment.

### PRIOR ART AND ITS DISADVANTAGES

End-to-end encryption (E2EE) is a technique used in communication systems where only communication equipment having established a connection to each other can access the content of certain data transmitted by means of the connection, the data useful for routing may be unencrypted.

End-to-end encryption systems are designed to be resistant to any attempt of surveillance or altering of data, as no third party can decrypt and therefore access the data thus communicated if they do not have the security keys used for encryption and decryption.

Thus, the content of the messages transmitted to the recipient communication equipment is encrypted locally by the emitter communication equipment even before the messages are sent through the connection, established on a communication path comprising intermediate equipment. This intermediate equipment, of the “middlebox” type for example, only relay encrypted messages, based on unencrypted routing data, and it is the recipient communication equipment which decrypts the message. The transaction is thus secure independently of the intermediate equipment which could be compromised. End-to-end encryption has become an increasingly widespread practice on the Internet.

Added to this is the evolution of the protocols constituting the Web service protocol stack, and more particularly the evolution of the transport layer of the OSI (Open Systems Interconnection) model of this protocol stack. The conjunction of these two phenomena contributes to reducing cooperation between the communication equipment located at the ends of the connection and the intermediate equipment or “middlebox”. An example of such a protocol is the transport layer protocol QUIC (Quick UDP Internet Connections), standardized at the IETF (Internet Engineering Task Force) in RFC9000 which is increasingly used in communication networks.

This reduction in cooperation between the communication equipment located at the ends of the connection and the intermediate equipment negatively impacts the performance of a connection established on the communication path comprising intermediate equipment.

Thus, for example, the reduction in cooperation between the communication equipment located at the ends of the connection and the intermediate equipment impacts the processing of the retransmission of lost data.

Indeed, two mechanisms for retransmission of lost data coexist: a so-called end-to-end retransmission mechanism implemented by either one of the communication equipment and a local mechanism implemented by one of the intermediate equipment. In the absence of cooperation between the communication equipment located at the ends of the connection and the intermediate equipment, these two retransmission mechanisms compete, increasing the risk of connection congestion without guaranteeing the correct retransmission of lost data.

There is therefore a need for a cooperation technique between the different equipment belonging to the same path allowing to reduce the effects of the aforementioned disadvantages.

### DESCRIPTION OF THE INVENTION

The invention responds to this need by proposing a method for managing a retransmission of data transmitted on a path established between a first communication equipment and a second communication equipment, said path comprising at least one intermediate equipment capable of retransmitting at least part of the missing data.

Such a method is implemented by the first communication equipment and comprising the following steps:
detecting missing data among the data transmitted by the second communication equipment,
processing, by an application of said first communication equipment, said transmitted data,
selecting, depending on a value of an intermediate performance parameter representative of a relative position of the intermediate equipment with respect to the first communication equipment and information relating to the missing data, a mode of processing said missing data among a plurality of modes of processing said missing data comprising a first mode of processing said missing data and at least a second mode of processing said missing data,
when the first mode of processing missing data, called missing data retransmission mode, is selected and when the value of the intermediate performance parameter is less than a first threshold, delaying, until the expiration of a countdown proportional to a first round-trip propagation duration between the first communication equipment and the intermediate node, an emission to the second equipment of a message requesting retransmission of the missing data.

Such a management method is based on knowledge of the nature of the errors impacting the missing data coupled with knowledge relating to the path taken by the transmitted data and the nodes that dot it. The present solution then allows the ends to adapt certain processing operations that they are required to implement in the context of processing missing data.

Thus, depending on a value of an intermediate performance parameter representative of a relative position of the intermediate equipment with respect to the first communication equipment and information relating to the missing data, the first communication equipment determines the benefit of a total or partial retransmission of the missing data and selects from the intermediate equipment and the second communication equipment the one which is best able to retransmit the missing data.

If it is determined that a retransmission of the missing data is of interest, for example as is the case when the missing data received is useful data or data which is not real-time data and that will be used once retransmitted, then the first communication equipment implements a first mode of processing the transmitted data based on the retransmission of the missing data.

As part of the implementation of this first processing mode, the first communication equipment uses a countdown of a duration whose value is proportional to a round-trip propagation duration between the first communication equipment and the intermediate node which gives it time to identify among the intermediate equipment and the second communication equipment which one is the most likely to retransmit the missing data.

This allows to improve cooperation between the different equipment and nodes belonging to the same path and more particularly the management of retransmissions of missing data packets and the management of the establishment of the connection with realistic parameters.

Thus, in order not to congest the connection and not to use resources unnecessarily at the second communication equipment, the first communication equipment delays the emission of a message requesting retransmission of the missing data to the second communication equipment until the countdown time has expired.

In one example, when the value of the intermediate performance parameter is greater than said first threshold, the message requesting retransmission of the missing data is emitted to the second communication equipment before the countdown expires.

When the missing data has been received before the countdown expires, the data retransmission management method implements a step of processing, by said application of said first communication equipment, the missing data transmitted by the intermediate node.

These missing data are for example emitted by the intermediate equipment in an ICMP SF message to the first communication equipment.

In another example, this missing data is for example emitted by the intermediate equipment in a message from the transport layer of the QUIC protocol specific to the QU1C_SF method, for example in a QUIC DATAGRAM specific to the QU1C_DGRAM_SF method or else a MASQUE datagram using a capsule specific to the MASQUE_CAP_SF method described in the normative document referenced

https://datatracker.ietf.org/doc/html/draft-ietf-masque-h3-datagram-05#section-4.

Indeed, the duration of the countdown being greater than or equal to a round-trip propagation duration between the first communication equipment and the intermediate node, this leaves time for the latter to retransmit the missing data via a local retransmission mechanism such as a HARQ (Hybrid Automatic Repeat Request) mechanism implemented by the intermediate node.

In one example, the data retransmission management method further comprises a step of determining the value of the intermediate performance parameter corresponding to a ratio between the first round-trip propagation duration between the first communication equipment and the intermediate node and a second round-trip propagation duration between the first communication equipment and the second communication equipment.

Thus, the first communication equipment can autonomously determine the value of the intermediate performance parameter.

When a second mode of processing said missing data, called mode without retransmission of missing data, is selected from said plurality of modes of processing said missing data, the countdown is not triggered.

Depending on the nature of the errors impacting the transmitted data, the first communication equipment may determine that a retransmission of the missing data is unnecessary. The transmitted data are then processed by the first communication equipment instead of being rejected as is the case in certain prior-art solutions.

Such a second mode of processing said transmitted data is selected for example when the missing data is padding data.

In such a scenario, the presence or absence of correction data will have no impact on the processing of the transmitted data and there is no point in cluttering the connection with retransmission requests. This is in particular the case for data packets in accordance with the QUIC protocol which contain encrypted padding data that only a transport layer application can identify as useful or not.

In one example, the second mode of processing said missing data is selected when the number of missing data exceeds a second threshold.

Indeed, when a number of missing data exceeds a certain threshold, this has the consequence that the retransmission requests and the retransmission of the missing data impose too high a load on the connection and on the communication equipment involved. Thus, it is advantageous not to request retransmission of missing data, regardless of the nature of the errors impacting the transmitted data, while processing them.

In another example, a parameter identifying the processing mode to be applied to the missing data is associated with the data transmitted by an application of a data link layer of said first communication equipment, said parameter identifying said processing mode to be applied to the missing data being intended to be used by an application of said first communication equipment when it implements said step of selecting a mode of processing the missing data.

The information relating to missing data used as part of the implementation of the data retransmission management method belongs to the group comprising:
the transmitted data being divided into data subgroups, an identifier of at least one data subgroup,
a position of at least one subgroup to which said missing data belongs in a stream of data subgroups transmitted by the second communication equipment,
a number of missing data,
a pointer indicating the missing data in the data stream transmitted by the second communication equipment.

In one example, the message requesting retransmission of the missing data to said second equipment comprises at least one of said previous pieces of information relating to the missing data.

Thus, the second communication equipment can identify the data to be retransmitted.

The invention also relates to communication equipment constituting a first end of a path established between said communication equipment and another communication equipment, said path comprising at least one intermediate equipment capable of retransmitting at least part of the received missing data, said equipment being capable of managing a retransmission of data transmitted on the communication path and comprising at least one processor configured to:
detect missing data among the data transmitted by the second communication equipment,
process, by an application of said first communication equipment, said transmitted data,
select, based on a value of an intermediate performance parameter representative of a relative position of the intermediate equipment with respect to the first communication equipment and information relating to the missing data, a mode of processing said missing data among a plurality of modes of processing said missing data comprising a first mode of processing said missing data and at least a second mode of processing said missing data,
when the first mode of processing missing data, called missing data retransmission mode, is selected and when the value of the intermediate performance parameter is less than a first threshold, delay, until the expiration of a countdown of a duration proportional to a first round-trip propagation duration between the first communication equipment and the intermediate node, an emission to the second equipment of a message requesting retransmission of the missing data.

The invention finally relates to a computer program product comprising program code instructions for implementing a method as described above, when executed by a processor.

The invention also aims at a computer-readable recording medium on which is recorded a computer program comprising program code instructions for executing the steps of the method according to the invention as described above.

Such a recording medium can be any entity or device capable of storing the program. For example, the medium may include a storage means, such as a ROM, for example a CD ROM or a microelectronic circuit ROM, or else a magnetic recording means, for example a USB key or a hard disk.

On the other hand, such a recording medium may be a transmissible medium such as an electrical or optical signal, which may be conveyed via an electrical or optical cable, by radio or by other means, so that the computer program it contains can be executed remotely. The program according to the invention can in particular be downloaded onto a network, for example the Internet network.

Alternatively, the recording medium may be an integrated circuit wherein the program is incorporated, the circuit being adapted to execute or to be used in the execution of the method which is the subject of the aforementioned invention.

### LIST OF THE FIGURES

Other purposes, features and advantages of the invention will appear more clearly upon reading the following description, given as a simple illustrative and non-limiting example, in relation to the figures, among which:

FIG. 1: this figure shows a system wherein the methods which are the subject of the invention are implemented,

FIG. 2: this figure shows the different steps implemented by the different elements of the system during the execution of a method for determining at least one value of an intermediate performance parameter PPI of the path,

FIG. 3: this figure shows the different steps implemented by the different elements of the system 1 during the execution of a method for managing a retransmission of data transmitted on the path,

FIG. 4: this figure schematically shows an intermediate node,

FIG. 5: this figure schematically shows communication equipment.

### DETAILED DESCRIPTION OF EMBODIMENTS OF THE INVENTION

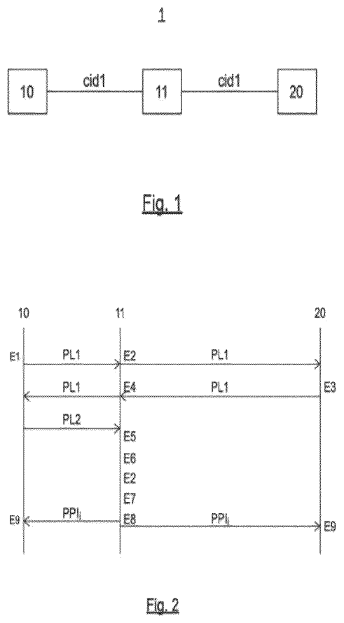

The general principle of the invention is based on determining the nature of the errors impacting data received by a first communication equipment via a connection established on a path established between the first communication equipment and a second communication equipment via at least one intermediate node in order to determine the relevance of a retransmission of missing data among the data received. Once the relevance of the retransmission of the data has been established, the invention is based on the determination by the first communication equipment of a value of an intermediate performance parameter relating to the connection established on this path and representative of a relative position of the intermediate equipment with respect to the first communication equipment and the second equipment. Such an intermediate performance parameter allows to improve cooperation between the different equipment and nodes belonging to the same path by providing all or part of this equipment with information relating to an intermediate performance of a connection established on the considered path. Knowledge of this intermediate performance information allows to improve, among others, the management of retransmissions of missing data packets and the management of connection establishment with realistic parameters.

[FIG. 1] shows a system 1 wherein the methods which are the object of the invention are implemented.

The system 1 comprises at least a first communication equipment 10, such communication equipment 10 is for example a domestic gateway such as a LiveBox®, a “smartphone” type mobile telephone, an IoT terminal, a connected car, a digital decoder or “Set Top Box”, etc.

The system 1 comprises at least one intermediate node 11 located in a communication network. Such an intermediate node 11 is for example an element of a mobile network (MEC (Mobile Edge Computing), C-RANs (Cloud Radio Access NetWorks)), a router, a gateway equipped with transport functions or application functions, or a proxy. The intermediate node 11 hosts one or more transmission functions. Such an intermediate node can also be embedded in a satellite or any other moving equipment, such as a drone.

Finally, the system 1 comprises a second communication equipment 20 such as a server for example.

A communication path cid1 through which data is intended to be transmitted, is established or in the process of being established between the first communication equipment 10 and the second communication equipment 20. This communication path is established through one or more intermediate nodes including the intermediate node 11.

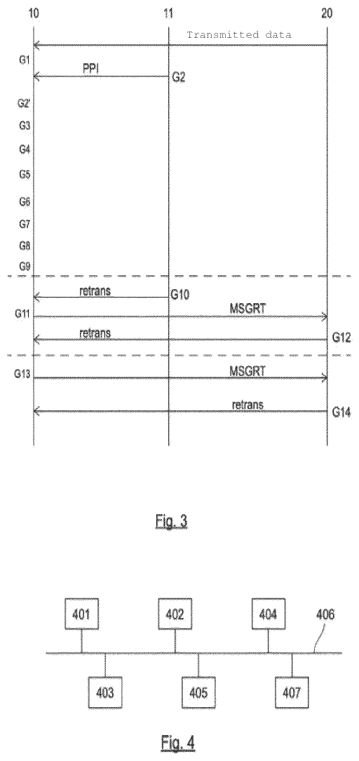

Such a communication path cid1 being established between the first communication equipment 10 and the second communication equipment 20, only these two communication equipment 10, 20 can access the content of the data transmitted on the path cid1. Thus, the intermediate node 11 does not access the data transmitted through the path cid1, it simply transmits them to the following equipment, either another intermediate node, or the second communication equipment 20. It is of course understood that certain data called routing data, such as the destination address, are accessible to the intermediate equipment to route the data but not the data comprised, for example, in transport or application layer fields of the messages.

[FIG. 2] shows the different steps implemented by the different elements of the system 1 during the execution of a method for determining at least one value of an intermediate performance parameter PPI of the path cid1.

In a step E1, the first communication equipment 10 emits a first data packet comprising in a header a first value of a latency parameter PL1 in accordance with the SpinBit mechanism. In an example, the first value PL1 of the latency parameter is 0.

The intermediate node 11 intercepts this first data packet, and timestamps and stores the first value PL1 of the latency parameter before transferring the first data packet to the second communication equipment 20 in a step E2.

In response to receiving the first data packet, the second communication equipment 20 emits, in a step E3, a second data packet to the first communication equipment 10 comprising in a header the first value of the latency parameter PL1.

The intermediate node 11 intercepts this second data packet, and timestamps and stores the first value PL1 of the latency parameter extracted from this second data packet before transferring the second data packet to the first communication equipment 10 in a step E4.

In a step E5, upon receiving the second data packet, the first communication equipment 10 emits a third packet comprising in a header a second value PL2 of the latency parameter distinct from the first value PL1. In an example, the second value PL2 of the latency parameter is 1.

The intermediate node 11 intercepts this third data packet, and timestamps and stores the second value PL2 of the latency parameter before transferring the third data packet to the second communication equipment 20 in a step E6. The communication equipment 10 and the communication equipment 20 can, thanks to this exchange of data packets, determine a round-trip propagation duration RTT between the first communication equipment 10 and the second communication equipment 20, if this is not done using acknowledgment packets.

In a step E7, the intermediate node 11 determines a first round-trip propagation duration RTT1011 between the first communication equipment 10 and the intermediate node 11, and a second round-trip propagation duration RTT1120 between the intermediate node 11 and the second communication equipment 20, by means of timestamp data associated with the different stored values of the latency parameter PL1 and PL2.

For example the round-trip propagation duration RTT1120 between the intermediate node 11 and the second communication equipment 20 is obtained thanks to the timestamps of the output of the first data packet and the arrival of the second data packet in the intermediate equipment 11.

The round-trip propagation duration RTT1011 between the first communication equipment 10 and the intermediate node 11 is in turn obtained thanks to the timestamps of the input of the second data packet and the output of the third data packet in the intermediate equipment 11.

The intermediate node 11 then determines, during a step E8, a value of an intermediate performance parameter PPI. In this embodiment, the intermediate performance parameter PPI is the ratio between the first round-trip propagation duration RTT1011 and the second round-trip propagation duration RTT1120:

$$PPI = \frac{RTT 1011}{RTT 1120}$$

For example, if the PPI value of the intermediate performance parameter is less than 1 then this means that the intermediate node 11 is (temporally) closer to the communication equipment 10 than to the communication equipment 20.

For example, when the PPI value of the intermediate performance parameter is greater than 1 then this means that the intermediate node 11 is closer to the communication equipment 20 than to the communication equipment 10.

The intermediate node 11 then proceeds to transmit the PPI value of the intermediate performance parameter thus obtained during a step E9. In the example shown in [FIG. 2], the intermediate node 11 transmits the PPI value of the intermediate performance parameter to the two communication devices 10 and 20.

In order to transmit the PPI value of the intermediate performance parameter, the intermediate node 11 can encode it and introduce it into a header field of a data packet transiting on the path cid1 to either one of the communication equipment 10, 20. In one example, the value of the intermediate performance parameter PPI is encoded in the ECN (“Explicit Congestion Notification”) bits of the header field of a data packet in accordance with the QUIC protocol.

For example, the PPI value of the intermediate performance parameter can be encoded on 2 bits where ‘01’ means that the intermediate node 11 is closer, temporally speaking, to the communication equipment 10 than to the communication equipment 20. In this scenario, the PPI value of the intermediate performance parameter is for example strictly less than 1. When the encoding of the PPI value of the intermediate performance parameter is ‘11’, this means that the intermediate node 11 is located temporally equidistant between the communication equipment 10 and the communication equipment 20. In this scenario, the PPI value of the intermediate performance parameter is for example equal to 1.

Finally, when the encoding of the PPI value of the intermediate performance parameter is ‘10’ this means that the intermediate node 11 is closer, temporally speaking, to the communication equipment 20 than to the communication equipment 10. In this case, the PPI value of the intermediate performance parameter is for example strictly greater than 1.

Of course, the PPI value of the intermediate performance parameter can be encoded in more than 2 bits.

Finally, such a method can also be applied to paths comprising more than two ends.

[FIG. 3] shows the different steps implemented by the different elements of the system 1 during the execution of a method for managing a retransmission of data transmitted on the path cid1.

In the remainder of the description of this method, the assumption that the first communication equipment 10 receives data transmitted by the second communication equipment 20 will be made. Of course, what is described below also applies to the case wherein the second communication equipment 20 receives data emitted by the first communication equipment 10, particularly in the case of a radio link, for example of the inter-satellite type, between the second communication equipment 20 and the intermediate equipment. In this method, the use of a countdown whose duration is proportional to a round-trip propagation duration between the first communication equipment and the intermediate node allows communication equipment to determine among the retransmission mechanism called end-to-end retransmission mechanism and the local mechanism, such as a HARQ mechanism implemented by the intermediate node, which is best able to offer the fastest and most efficient retransmission of lost data.

Thus in a step G1, the first communication equipment 10 detects an anomaly in the data packets received from the second communication equipment 20. The detected anomaly may be the loss of a data packet or part of a data packet such as a subgroup of data, a data packet received late, the reception of a de-sequenced data packet, or the reception of a data packet part of which is erroneous or missing. In other words, the first communication equipment 10 determines that there is missing data among the data transmitted by the second communication equipment 20.

In a first example, the first communication equipment 10 receives in a step G2 which may be before, after or concomitant with step G1, a value of the intermediate performance parameter PPI obtained by the intermediate node as described with reference to [FIG. 2], Still in this step G2, the first equipment 10 also measures a first round-trip propagation duration RTT1011 between the first communication equipment 10 and the intermediate node 11

In a second example, during a step G2′, the communication equipment 10 proceeds to measure the first round-trip propagation duration RTT1011 between the first communication equipment 10 and the intermediate node 11, and a second round-trip propagation duration RTT1020 between the first communication equipment 10 and the second communication equipment 20, by means of timestamp data. The first communication equipment 10 then determines a value of the intermediate performance parameter PPI.

In this example, the value of the intermediate performance parameter PPI is obtained from the first round-trip propagation duration RTT1011 between the first communication equipment 10 and the intermediate node 11, and from the second round-trip propagation duration RTT1020 between the first communication equipment 10 and the second communication equipment 20. Just like the value of the intermediate performance parameter PPI obtained according to the method described with reference to [FIG. 2], the value of the intermediate performance parameter PPI obtained during this step G2′ is also representative of a relative position of the intermediate equipment with respect to the first communication equipment.

Thus, when the value of the intermediate performance parameter PPI is calculated by the first communication equipment 10 then, if the value PPI of the intermediate performance parameter is less than ½ then this means that the intermediate node 11 is (temporally) closer to the communication equipment 10 than to the communication equipment 20. As a corollary, when the value PPI of the intermediate performance parameter is greater than ½ then this means that the intermediate node 11 is closer to the communication equipment 20 than to the communication equipment 10.

At the end of step G2 or step G2′, when it has the necessary information, the first communication equipment 10 can determine, in a step G3, a countdown of a duration proportional to a first round-trip propagation duration between the first equipment 10 and the intermediate node 11.

In a step G4, an application of the data link layer of the communication equipment 10 collects information relating to missing data such as, among others:
the data packets being made up of data subgroups, an identifier of at least one data subgroup,
a position of at least one subgroup to which said missing data in said data packet belongs,
a number of missing data,
a pointer indicating missing data in the data packet.

In a step G5, an application of the data link layer of the communication equipment 10 introduces a parameter identifying a processing mode to be applied to the missing data in a header field of the data packet comprising the missing data.

In one example, the application of the data link layer reuses ECN (“Explicit Congestion Notification”) bits from the header field of a data packet in accordance with the IP protocol to encode the parameter identifying the processing mode to be applied to the transmitted data.

Thus, such a parameter identifying a first processing mode to be applied to the missing data, called unreliable mode, can be encoded on 2 bits where ‘01’ means that a retransmission of the missing data is requested, this is the case for example when the missing data concerns the payload of the data packet or the data transmitted is not real-time data.

Such a parameter identifying a second processing mode to be applied to the transmitted data, called extremely unreliable mode, can be encoded on 2 bits where ‘11’ means that a retransmission of the missing data is not requested because the missing data is padding data or that the transmitted data is real-time data whose processing does not support retransmission.

Finally, such a parameter identifying a third processing mode to be applied to the transmitted data, also called extremely unreliable mode, can be encoded on 2 bits where ‘10’ means that a retransmission of the missing data will not be requested because the number of missing data exceeds a certain threshold beyond which the retransmission of missing data negatively impacts the performance of the connection and/or the performance of the communication equipment 10, 20 and/or the intermediate equipment 11.

Other modes of processing the transmitted data can be considered in order to meet the needs of the applications embedded in the first communication equipment 10 for which the transmitted data are intended.

At the end of this step G5, the application of the data link layer transfers, in a step G6, the data transmitted by the second communication equipment 20 to an application of the network layer despite the presence of missing data among the data received. Thus, the buffers of the data link layer are freed and can receive a new data stream. The network layer application then processes this data. Such processing may consist, among others, of destruction of the transmitted data, decryption of the transmitted data, transfer of the transmitted data to a transfer layer application, etc. During this step G6, the information relating to missing data collected during step G3 as well as the countdown duration are also transmitted to the transport layer application.

Upon receiving the processed data packets and during a step G7, the application of the transport layer selects according to the parameter identifying a processing mode to be applied to the transmitted data comprised in a header field of the data packet which of the three data processing modes must be implemented.

When the missing data processing mode selected during step G7 is the first processing mode, in step G8 the application of the transport layer triggers the countdown.

In a step G9 concomitant with step G8, the application of the transport layer of the communication equipment 10 determines, depending on the value of the intermediate performance parameter PPI, whether it is more judicious to wait for a retransmission of the missing data from the intermediate equipment 11 or if it is more judicious to directly request an end-to-end retransmission from the second communication equipment 20.

For example, if the value PPI of the intermediate performance parameter calculated by the intermediate equipment 11 is less than 1, then this means that the intermediate node 11 is (temporally) closer to the communication equipment 10 than the communication equipment 20 and that it is more judicious to wait for a retransmission of the missing data from the intermediate equipment 11.

When the value PPI of the intermediate performance parameter calculated by the intermediate equipment 11 is greater than 1, then this means that the intermediate node 11 is closer to the communication equipment 20 and that it is more judicious to directly request an end-to-end retransmission to the second communication equipment 20.

Thus, in the case where it is more judicious to wait for a retransmission of the missing data from the intermediate equipment 11, the first communication equipment 11 delays the emission, to the second communication equipment 20, of an MSGRT message requesting retransmission of missing data. The communication equipment 10 delays the emission of the MSGRT message until the countdown expires.

This leaves time for the intermediate node 11 to implement the HARQ mechanism and transmit the missing data to the first communication equipment 10 in a step G10.

This delay in the transmission of the MSGRT message to the second communication equipment 20 allows not to congest the path cid1 and not to use resources unnecessarily at the second communication equipment 20.

When the countdown expires and the missing data supposed to have been transmitted by the intermediate node 11 has not been received, the first communication equipment 10 can emit said MSGRT message requesting the retransmission of the missing data to the second communication equipment 20 during a step G11.

After receiving this MSGRT message, the communication equipment 20 retransmits the missing data to the first communication equipment 10 in a step G12.

In the case where it is more judicious to directly request an end-to-end retransmission to the second communication equipment 20, the first communication equipment 10 directly requests said MSGRT message requesting the retransmission of the missing data to the second communication equipment 20 during a step G13, without waiting for the countdown to expire.

After receiving this MSGRT message, the communication equipment 20 retransmits the missing data to the first communication equipment 10 in a step G14.

In one example, the missing data is retransmitted by the second communication equipment 20 in a network level control packet, for example in an ICMP ICMP_SF type message specific to the method which is the subject of this application.

In another example, the missing data is retransmitted by the second communication equipment 20 in a message from the transport layer of the QUIC protocol specific to the QUIC_SF method, for example in a QUIC DATAGRAM specific to the QUIC_DGRAM_SF method or else a MASQUE datagram using a capsule specific to the MASQUE_CAP_SF method described in the normative document referenced

https://datatracker.ietf.org/doc/html/draft-ietf-masque-h3-datagram-05#section-4.

Upon receiving the retransmission messages, an application of the network layer of the communication equipment 10 transmits the missing data retransmitted to an application of the transport layer of the communication equipment 10 in a setsockopt( ) notification of type SO_BLOCK_RTX specific to the method which is the object of the present solution, the retransmitted data and the values of an identifier of these data repID, of an identifier indicating the received missing data in the data packet repPtr, of a value of the number of data repLen contained in the message ICMP_SF.

```
  struct rctx {
  u_long repID;
  uint32_t repPtr;
  uint32_t repLen;
  char* subfrm;
  };
  setsockopt(sockfd, SOL_SOCKET, SO_BLOCK_RTX,
(const char*)&retx, sizeof(retx))
```

The retransmitted data is available at the address subfrm for an arbitrary duration which may correspond to the duration of the countdown in order to allow time for the transport layer application to access this data.

Alternatively, subfrm is a char* function pointer (*subfrm) ( ).

The transport layer application can call this function by calling subfrm(repID, . . . ) which then returns the retransmitted missing data or empty data if nothing has been retransmitted, or if the subfrm( ) function is called after countdown expiration, for example.

When the communication equipment 10 is in possession of the missing data retransmitted by the communication equipment 20, at the end of step G9 or G11, the application of the transport layer proceeds to their processing during a step G12. Such processing consists of a transmission of all the data, transmitted data and retransmitted missing data, to one or more applications of the application layer of the first communication equipment 10.

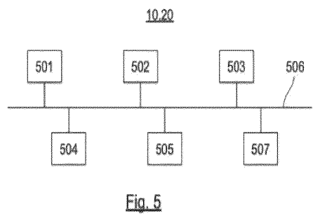

When the missing data processing mode selected in step G7 is the second processing mode or the third processing mode, no retransmission of missing data is required or expected and the countdown is not triggered.

[FIG. 4] schematically shows an intermediate node 11.

The intermediate node 11 may comprise at least one hardware processor 401, a storage unit 402, an input device 403, a display device 404, an interface unit 405, and a network interface 407 which are connected to each other through a bus 406. Of course, the constituent elements of the intermediate node 11 can be connected by means of a connection other than a bus.

The processor 401 controls the operations of the intermediate node 11. The storage unit 402 stores at least one program to determine at least one value of an intermediate performance parameter PPI of a path cid1 established between a first communication equipment 10 and a second communication equipment 20, to be executed by the processor 401, and various data, such as parameters used for calculations carried out by the processor 401, intermediate data of calculations carried out by the processor 401, etc. The processor 401 can be formed by any known and suitable hardware or software, or by a combination of hardware and software. For example, the processor 501 can be formed by dedicated hardware such as a processing circuit, or by a programmable processing unit such as a Central Processing Unit which executes a program stored in a memory thereof.

The storage unit 402 may be formed by any suitable means capable of storing the program, and data in a computer readable manner. Examples of storage unit 402 comprise non-transitory computer-readable storage media such as solid-state memory devices, and magnetic, optical, or magneto-optical recording media loaded into a read and write unit. The program causes the processor 401 to execute a method for managing the retransmission of missing data according to one embodiment of the invention.

The input device 403 may be formed by a keyboard, a pointing device such as a mouse to be used by a user to enter commands. The display device 404 may be formed by a display device for displaying, such as for example a graphical user interface (GUI). The input device 403 and the display device 404 can be formed integrally by means of a touch screen, for example.

The interface unit 405 provides an interface between the intermediate node 11 and an external apparatus. The interface unit 405 can communicate with the external apparatus via a wired or wireless connection. Such an external apparatus is for example a laptop computer.

A network interface 407 provides a connection between the intermediate node 11 and another intermediate node 11 via a communication network, such as the Internet, or communication equipment 10, 20. The network interface 407 can provide, depending on its nature, a wired or wireless connection to the network.

[FIG. 5] schematically shows communication equipment 10, 20.

The communication equipment 10,20 may comprise at least one hardware processor 501, a storage unit 502, an input device 503, a display device 504, an interface unit 505, and a network interface 507 which are connected to each other via a bus 506. Of course, the constituent elements of the communication equipment 10, 20 can be connected by means of a connection other than a bus.

The processor 501 controls the operations of the communication equipment 10, 20. The storage unit 502 stores at least one program to manage a retransmission of data transmitted on a path cid1 established between the first communication equipment 10 and the second communication equipment 20 to be executed by the processor 501, and various data, such as parameters used for calculations carried out by the processor 501, intermediate calculation data carried out by the processor 501, etc. The processor 501 may be formed by any known and suitable hardware or software, or by a combination of hardware and software. For example, the processor 501 can be formed by dedicated hardware such as a processing circuit, or by a programmable processing unit such as a Central Processing Unit which executes a program stored in a memory thereof.

The storage unit 502 may be formed by any suitable means capable of storing the program, data in a computer readable manner. Examples of storage unit 502 comprise non-transitory computer-readable storage media such as solid-state memory devices, and magnetic, optical, or magneto-optical recording media loaded into a read and write unit. The program causes the processor 501 to execute a method for managing the retransmission of missing data according to one embodiment of the invention.

The input device 503 may be formed by a keyboard, a pointing device such as a mouse to be used by a user to enter commands. The display device 504 may be formed by a display device for displaying, such as for example a graphical user interface (GUI). The input device 503 and the display device 504 can be formed integrally by means of a touch screen, for example.

The interface unit 505 provides an interface between the communication equipment 10, 20 and an external apparatus. The interface unit 505 can communicate with the external apparatus via a wired or wireless connection.

A network interface 507 provides a connection between the communication equipment 10, 20 and an intermediate node 11 via a communication network, such as the Internet. The network interface 507 can provide, depending on its nature, a wired or wireless connection to the network.

1. A method for managing a retransmission of data transmitted on a path established between a first communication equipment and a second communication equipment, said path comprising at least one intermediate equipment capable of retransmitting at least part of missing data, said method being implemented by the first communication equipment and comprising:
detecting missing data among the data transmitted by the second communication equipment,
processing, by an application of said first communication equipment, said transmitted data,
selecting, depending on a value of an intermediate performance parameter representative of a relative position of the intermediate equipment with respect to the first communication equipment and information relating to the missing data, a mode of processing said missing data among a plurality of modes of processing said missing data comprising a first mode of processing said missing data and at least a second mode of processing said missing data,
in response to the first mode of processing missing data, called missing data retransmission mode, being selected and the value of the intermediate performance parameter being less than a first threshold, delaying, until expiration of a countdown of a duration proportional to a first round-trip propagation duration between the first communication equipment and the intermediate equipment, an emission to the second equipment of a message requesting retransmission of the missing data.

2. The method for managing a data retransmission according to claim 1 wherein, when the value of the intermediate performance parameter is greater than said first threshold, the message requesting retransmission of the missing data is emitted to the second communication equipment before the countdown expires.

3. The method for managing a retransmission of data according to claim 1 comprising processing, by said application of said first communication equipment, the missing data transmitted by the intermediate equipment when the missing data were received before the countdown expires.

4. The method for managing a data retransmission according to claim 1 further comprising determining the value of the intermediate performance parameter corresponding to a ratio between the first round-trip propagation duration between the first communication equipment and the intermediate equipment and a second round-trip propagation duration between the first communication equipment and the second communication equipment.

5. The method for managing a retransmission of data according to claim 1 wherein when the second mode of processing said missing data, called mode without retransmission of missing data, is selected from said plurality of modes of processing said missing data, the countdown is not triggered.

6. The method for managing a data retransmission according to claim 3 wherein the second mode of processing said missing data is selected when the missing data is padding data.

7. The method for managing a data retransmission according to claim 5 wherein the second mode of processing said missing data is selected when a number of the missing data exceeds a second threshold.

8. The method for managing a data retransmission according to claim 1, wherein a parameter identifying the processing mode to be applied to the missing data is associated with said data transmitted by an application of a data link layer of said first communication equipment, said parameter identifying said processing mode to be applied to the missing data being intended to be used by an application of the transport layer of said first communication equipment when said application of the transport layer implements said selecting a mode of processing the missing data.

9. The method for managing a retransmission of data according to claim 1, wherein the information relating to the missing data belongs to the group consisting of:
the transmitted data being divided into data subgroups, an identifier of at least one of the data subgroups,
a position of at least one subgroup to which said missing data belongs in a stream of data subgroups transmitted by the second communication equipment,
a number of the missing data,
a pointer indicating the missing data in the data stream transmitted by the second communication equipment.

10. The method for managing a retransmission of data according to claim 1, wherein said message requesting retransmission of the missing data to said second equipment comprises at least one of said information relating to the missing data.

11. A communication equipment constituting a first end of a path established between said communication equipment and another communication equipment, said path comprising at least one intermediate equipment capable of retransmitting at least part of received missing data, said communication equipment being capable of managing a retransmission of data transmitted on the communication path and comprising:
at least one processor configured to:
detect missing data among the data transmitted by the second communication equipment,
process, by an application of said first communication equipment, said transmitted data,
select, based on a value of an intermediate performance parameter representative of a relative position of the intermediate equipment with respect to the first communication equipment and information relating to the missing data, a mode of processing said missing data among a plurality of modes of processing said missing data comprising a first mode of processing said missing data and at least a second mode of processing said missing data,
in response to the first mode of processing missing data, called missing data retransmission mode, being selected and the value of the intermediate performance parameter being less than a first threshold, delay, until expiration of a countdown of a duration proportional to a first round-trip propagation duration between the first communication equipment and the intermediate equipment, an emission to the second equipment of a message requesting retransmission of the missing data.

12. A non-transitory computer readable medium comprising a computer program product stored thereon comprising instructions which, when these instructions are executed by a processor of a first communication equipment, configure the processor to implement a method for managing a retransmission of data transmitted on a path established between the first communication equipment and a second communication equipment, said path comprising at least one intermediate equipment capable of retransmitting at least part of missing data, said method being implemented by the first communication equipment and comprising:
detecting missing data among the data transmitted by the second communication equipment,
processing, by an application of said first communication equipment, said transmitted data,
selecting, depending on a value of an intermediate performance parameter representative of a relative position of the intermediate equipment with respect to the first communication equipment and information relating to the missing data, a mode of processing said missing data among a plurality of modes of processing said missing data comprising a first mode of processing said missing data and at least a second mode of processing said missing data,
in response to the first mode of processing missing data, called missing data retransmission mode, being selected and the value of the intermediate performance parameter being less than a first threshold, delaying, until expiration of a countdown of a duration proportional to a first round-trip propagation duration between the first communication equipment and the intermediate equipment, an emission to the second equipment of a message requesting retransmission of the missing data.
